(19) United States
(12) Patent Application Publication
(10) Pub. No.: US 2011/0245979 A1
(43) Pub. Date: Oct. 6, 2011

(54) Arrangement with an Electronically Adjustable Piece of Furniture and Method for Wireless Operation Thereof

(75) Inventor: Walter Koch, Schwanberg (AT)

(73) Assignee: LOGICDATA Electronic & Software Entwicklungs GmbH, Deutschlandsberg (AT)

(21) Appl. No.: 13/123,462

(22) PCT Filed: Oct. 6, 2009
(86) PCT No.: PCT/EP2009/062975

§ 371 Date: Jun. 8, 2011

(30) Foreign Application Priority Data
Oct. 10, 2008 (DE) 102008051133.1

(51) Int. Cl. G05B 19/00

(52) U.S. Cl. 700/275

(57) ABSTRACT

An arrangement with an electronically adjustable piece of furniture is disclosed. The piece of furniture includes at least one electric drive motor, at least one functional region and at least one controller for controlling the drive motor and the functional region. A programmable operating unit is designed for wireless operation of the piece of furniture and a communication device capable of wireless data transmission between the piece of furniture and the operating unit. A method for wireless operation of an arrangement with an electronically adjustable piece of furniture is also disclosed.

This patent application is a national phase filing under section 371 of PCT/EP2009/062975, filed Oct. 6, 2009, which claims the priority of German patent application 10 2008 051 133.1, filed Oct. 10, 2008, each of which is incorporated herein by reference in its entirety.

### TECHNICAL FIELD

The invention pertains to an arrangement with an electronically adjustable piece of furniture. Furthermore, the invention pertains to a method for the wireless operation of an arrangement with an electronically adjustable piece of furniture.

### BACKGROUND

Electronically adjustable pieces of furniture are to be found, for example, in work and office settings, for instance, in the form of height-adjustable tables or height and incline adjustable chairs. Electronically adjustable beds are to be found, for example, in hospital settings. Such pieces of furniture make an improvement of ergonomics in the areas of work and health care possible.

The progressive advancement of the underlying technology, such as the further partitioning of a chair into additional functional regions, such as a moveable headrest or a heatable seating surface separate from the backrest, as well as diversification of the available functions, place higher demands on the operation of an electronically adjustable piece of furniture. The operation of this furniture via switches that are directly on the piece of furniture or on a device connected to the piece of furniture with a cord is possible. Due to the variety of selectable functions and to ensure the ergonomics of the piece of furniture as well as of the operation thereof, it appears to be desirable to optimize the operation.

### SUMMARY OF THE INVENTION

Embodiments of the invention specify an arrangement and a method that permit a user-friendly operation of an electronically adjustable piece of furniture.

In one embodiment the piece of furniture displays, in an arrangement with an electronically adjustable piece of furniture, a programmable operating unit and a communication device. The piece of furniture includes at least one electric drive motor, at least one functional region and at least one control unit to control the drive motor and the functional region. The programmable control unit is designed for the wireless operation of the piece of furniture. The communication device is suited to the wireless transmission of data between the piece of furniture and the control unit, i.e., suited to bidirectional data transfer.

A user inputs an instruction to the control unit to direct a functional region of the piece of furniture. The instruction is transmitted to the control unit of the piece of furniture via the communication device and, with the help of the drive motor, is executed in the functional region. The controller transmits via the communication device an acknowledgement that is displayed on the operating unit for the user.

The wireless operation of the piece of furniture via operating unit and communication device advantageously increases the user-friendliness and the ergonomics.

Functional region describes a single controllable region of a piece of furniture that is connected, for example, via a joint, to an adjoining region. On a chair, for instance, the seat and the backrest can each constitute a functional region.

The drive motor can be installed in the connecting element, e.g., the joint, and is used to adjust the position of two functional regions relative to one another or for adjusting the height of the entire piece of furniture. The drive motor is controlled via commands from the controller attached to the piece of furniture.

The communication device includes a wireless data net suitable for the wireless transmission of data. Preferably, for the data transmission, an infrared line or a local radio network is laid as a basis. Therefore the communication device can be based, for example, on the standard of a wireless local area network WLAN, as per IEEE 802.11, DECT [Digital Enhanced Cordless Telecommunications], or Bluetooth, or be accomplished with the help of a proprietary radio transmission process.

In a further development, the controller includes a first communication interface for the bidirectional exchange of data with the operating unit. The operating unit exhibits a second communication interface for the bidirectional exchange of data with the controller.

The first and the second communication interface are each designed for data transmission via the communication device.

In a further embodiment, the programmable operating unit has a microprocessor, a program memory, a data storage and an input-output device. The input-output device is designed for the display of information for a user and for input of instructions from the user.

Via the input-output device, the operating unit takes instructions entered by the user and temporarily saves them in the data storage. By means of the microprocessor and a program saved in the program memory, the instruction is converted to a command executable by the controller of the piece of furniture, and via the second communication interface, transmitted to the controller. An acknowledgement received by the controller at the second communication interface is converted to a message understandable to the user and is displayed on the input-output device.

Because the operating unit is programmable, the operation can be customized to the user with little effort, or can be tailored to a specific application. This contributes considerably to the increased user-friendliness of the operation of the electronically adjustable piece of furniture.

In a further development, the input-output device features a touch-sensitive surface for the input of instructions.

The touch-sensitive surface is put into effect, for example, with a so-called touch screen. The surface is operated either with a special stylus or with one or more fingers of the user. For instance, an object displayed on the input-output device, which may represent a functional region of the electronically adjustable piece of furniture, can be selected by touch to operate possible functions, or the object is maximized or minimized.

The programmable operating unit can, for example, include a PDA (Personal Digital Assistant).

In a further embodiment, the operating unit has a functional unit that is designed to recognize spoken instructions of the user and convert them into commands executable by the operating unit.

Thus the functional unit accomplishes speech recognition.

The operation of the electronically adjustable piece of furniture via spoken words of the user advantageously increases the user-friendliness considerably, because this correlates most closely to the natural communication behavior of humans.

In a further development the operating unit features a sensor that is designed to detect movements of the operating unit carried out by the user.

The sensor may, for example, be a motion sensor or an acceleration sensor.

For instance, a clockwise rotation of the operating unit by the user brings a reclining chair into an upright position. Advantageously, the ease of operation is thus further improved.

The information displayed on the input-output device includes error messages, acknowledgements, operating instructions or the like.

In one embodiment, a method for the wireless operation of an arrangement with an electronically adjustable piece of furniture exhibits the following steps.

An instruction is input by the user on an operating unit. The instruction is converted into a command executable by a controller of the electronically adjustable piece of furniture. The command is wirelessly transmitted to the controller of the piece of furniture via a communication device. The command is executed by means of the controller of the piece of furniture. An acknowledgement of the controller of the piece of furniture is wirelessly transmitted to the operating unit via the communication device and the display of the acknowledgement on the operating unit.

Because the piece of furniture can be operated wirelessly, the user can move independently of the adjustable piece of furniture. This greater freedom notably increases the user-friendliness.

In a further development, the input of the instruction on the operating unit occurs via touch, or via spoken words, or via movement of the operating unit, or is initiated time-controlled by the operating unit.

Touch occurs with a specifically designed stylus or with one or more fingers. Furthermore, it is possible for a previously entered instruction or a sequence of previously entered instructions to be executed at a programmed time. This occurs in conjunction with a timer in the operating unit, specifically in its microprocessor.

Advantageously, therefore, in comparison to the available input of instructions via keys, the described operating unit and the accompanying method considerably increase the user-friendliness of the operation of the electronically adjustable piece of furniture.

In a further embodiment, the display of the acknowledgement occurs graphically in the form of a status message, an error message or an operating instruction.

The status message contains information pertaining to the progress of the execution of an entered instruction. For example, the process of the leaning back of a controlled chair is depicted symbolically on the input-output device. By an error message the user is notified that an instruction could not be carried out. To help the user with the operation of the piece of furniture an operating instruction is displayed.

### BRIEF DESCRIPTION OF THE DRAWINGS

The invention will subsequently be further explained by means of two design examples by reference to FIGS. 1 and 2.

FIG. 1 shows an embodiment of an arrangement with an electronically adjustable piece of furniture; and

FIG. 2 shows a further embodiment of an arrangement with an electronically adjustable piece of furniture.

### DETAILED DESCRIPTION OF ILLUSTRATIVE EMBODIMENTS

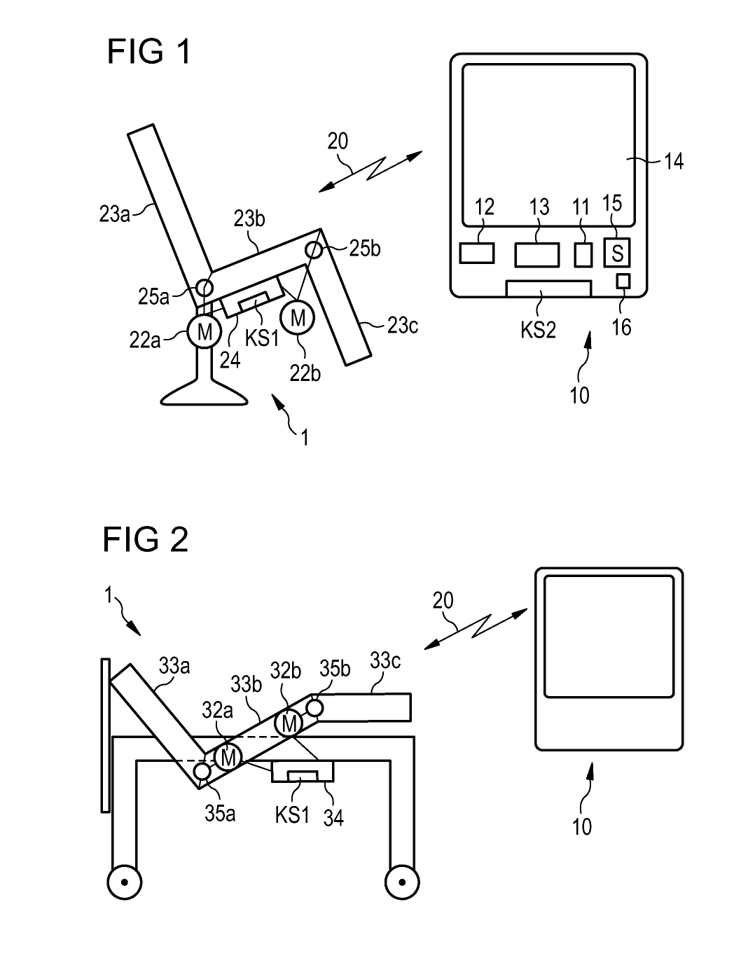

FIG. 1 shows an embodiment of an arrangement with an electronically adjustable piece of furniture. The arrangement includes the electronically adjustable piece of furniture 1, the communication device 20, as well as the programmable operating unit 10. In this example the electronically adjustable piece of furniture 1 includes a chair. The chair 1 has two drive motors 22a, 22b, three functional regions 23a, 23b, 23c, as well as a controller 24.

The controller 24 includes a first communication interface KS1. The functional region 23a that forms the backrest of the chair is connected to the functional region 23b that forms the seat of the chair by means of a first joint 25a. The functional region 23b is connected to functional region 23c that forms the foot of the chair by means of a second joint 25b. The first joint 25a is linked with the first drive motor 22a. The second joint 25b is linked with the second drive motor 22b. The first drive motor 22a as well as the second drive motor 22b are each linked to the controller 24.

The programmable operating unit 10 includes a microprocessor 11, a program memory 12, a data storage 13, an input-output device 14, as well as optionally a functional unit 15 and optionally a sensor 16. Furthermore the operating unit 10 includes a second communication interface KS2. The input-output device 14 includes a touch-sensitive display, a so-called touch screen, that allows the user to input instructions by touching the surface and displays information in the form of pictures and text.

Through the interaction of microprocessor 11, program memory 12 and data storage 13, the operating unit achieves functionalities equivalent to those of a calculator or computer. The physical dimensions of operating unit 10 are such that the user can hold it in one hand and operate it with the same hand or with the other hand. The optional functional unit 15 realizes speech recognition. The optional sensor 16 detects motion that a user carries out with the operating unit 10. These are interpreted by the microprocessor 11 as instructions for the electronically adjustable piece of furniture 1. Preferably, the operating unit 10 encompasses a standard operating system on which the program memory 12 and the data storage 13 are set up.

The communication device 20 encompasses a wireless data network that may, for instance, be based on a standard such as DECT, Bluetooth or WLAN, or on a proprietary radio transmission process. The first and second communication interfaces KS1 and KS2 are each configured in such a way that they can transmit data via the communication device 20.

Through input of instructions on the input-output device 14 of the programmable operating unit 10, a user can activate various functions on the electronically adjustable piece of furniture 1. Specifically this occurs as a result of the user entering the instruction via stylus or finger, optionally via speech input or via movement of operating unit 10. This instruction is converted by the operating unit 10 to a command executable by the controller 24 of the piece of furniture, and transmitted to the latter via the communication device 20. The controller 24 translates the executable command into a corresponding movement of the first and/or second drive motors 22a, 22b, which, for instance, through movement of the first or second joint 25a, 25b, carry out the desired function. Subsequently, the controller 24 transmits an acknowledgement to the operating unit 10 via the communication device 20. The acknowledgement is visibly displayed for the user on the input-output device 14.

Adjustable functions may be, for example, adjustment of the position of a functional region 23a, 23b, 23c, wherein the position of the functional region may be adjusted individually or in combination with another functional region. Furthermore, for example, a heating function or massage function installed in a functional region may be adjusted in several stages.

With the aid of the programmable operating unit 10, which preferably has a standard operating system available, a personalization of the operation is achieved. For instance, various profiles can be saved for the personalization of a chair for any one user. One profile can, for example, carry out positioning for sleeping. Another profile may be set for the position for reading. Therefore, if the profile “sleeping” is selected on the operating unit 10, the chair 1 is adjusted by positioning of the functional regions 23a, 23b and 23c to a position once set by the user, in which the user is able to sleep well. The use of profiles simplifies the switching between different base positions, such as sleeping and reading, since the user does not have to operate several elements each time, but can switch back and forth between different profiles via one operating step.

In addition it is intended for a user to save his profiles. As a result, an adaptation to different users is easily possible.

For example, the following application is realized. A user has a profile set for a working position of chair 1. To bring the chair 1 into the working position, the user speaks the instruction “chair in my working position” into the programmable operating unit 10. The voice of the user is recognized by the functional unit 15 for speech recognition. The saved position adjustments for the profile “working position” are read from the data storage 13. The appropriate commands to move the drive motors 22a, 22b are transmitted from the operating unit 10 to the controller 24. Controller 24 causes the adjustment of the chair 1 through movement of the functional regions 23a, 23b and 23c by means of the drive motors 22a and 22b. As soon as the adjustment is completed, the controller 24 transmits an “OK” message to the operating unit 10. This confirmation of the execution of his instruction is displayed to the user on the input-output device 14 or is communicated audibly.

Furthermore, the intent is to assist the user in the operation of the piece of furniture 1 by display of help information. Preferably, the operating instructions are available in electronic form on the operating unit 10, so that operating instructions on paper are unnecessary. For instance, chair 1 is depicted as a symbol on the input-output device 14. By touching a functional region, this region can be displayed maximized. With further touching of a region, help information or operating instructions pertaining to this region are electronically displayed.

Through the use of a timer already present in the operating unit 10, it is possible to switch functions on or off on a timed schedule. For example, a heater function installed in the seat 23b of chair 1 is switched on in the morning so that the user finds a warm chair when he arrives in his office.

FIG. 2 shows a further embodiment of an arrangement with an electronically adjustable piece of furniture. The piece of furniture 1 is, in this case, a bed, e.g. a hospital bed. The bed 1 is in communication with the operating unit 10 via the communication device 20. The bed 1 exhibits three functional regions 33a, 33b and 33c. The functional region 33a that forms the upper part of the lying surface of the bed 1 is connected to the functional region 33b that forms the middle part of the lying surface of the bed 1 via a first joint 35a. The functional region 33c that forms the foot part of the bed 1 is connected to functional region 33b via a second joint 35b. The first joint 35a is linked to a first drive motor 32a. The second joint 35b is linked to a second drive motor 32b. The drive motors 32a and 32b are each linked to a controller 34. The controller 34 has the first communication interface KS1. The operation of the bed 1 occurs as described under FIG. 1 and is appropriately adapted to the functional regions 33a, 33b and 33c.

Corresponding functional regions are defined in another arrangement with an electronically adjustable table and realized by means of the characteristics of the patent claims.

The following list of reference symbols may be used in conjunction with the drawings:
1 Piece of furniture
22a, 22b Drive motor
23a, 23b, 23c Functional region
24 Controller
25a, 25b Joint
32a, 32b Drive motor
33a, 33b, 33c Functional region
34 Controller
35a, 35b Joint
10 Operating unit
11 Microprocessor
12 Program memory
13 Data storage
14 Input-output device
15 Functional unit
16 Sensor
20 Communication device
KS1, KS2 Communication interface

1. An arrangement for an electronically adjustable piece of furniture, the arrangement comprising:
a piece of furniture with at least one electronic drive motor, at least one functional region and at least one controller to control the at least one electronic drive motor and the at least one functional region,
a programmable operating unit configured for wireless operation of the piece of furniture; and
a communication device configured for wireless transmission of data between the piece of furniture and the programmable operating unit.

2. The arrangement according to claim 1, wherein the at least one controller includes a first communication interface for bidirectional exchange of data with the programmable operating unit, and the programmable operating unit includes a second communication interface for bidirectional exchange of data with the at least one controller.

3. The arrangement according to claim 2, wherein the programmable operating unit comprises:
a microprocessor;
a program memory;
a data storage; and
an input-output device configured to display information for a user and for input of instructions from the user.

4. The arrangement according to claim 3, wherein the input-output device comprises a touch-sensitive surface for the input of instructions.

5. The arrangement according to claim 3, wherein the programmable operating unit includes a functional unit configured to recognize spoken instructions of the user and to convert the spoken instructions into instructions executable by the programmable operating unit.

6. The arrangement according to claim 3, wherein the programmable operating unit further comprises a sensor configured to detect a movement of the programmable operating unit carried out by the user.

7. The arrangement according to claim 1, wherein the piece of furniture comprises a bed, a chair or a table.

8. A method for wireless operation of an arrangement with an electronically adjustable piece of furniture, the method comprising:
receiving an instruction from a user at an operating unit;
converting the instruction into a command executable by a controller of the electronically adjustable piece of furniture;
wirelessly transmitting the command to the controller of the piece of furniture via a communication device;
execution of executing the command with the aid of the controller of the piece of furniture;
wirelessly transmitting an acknowledgement from the controller of the piece of furniture to the operating unit via the communication device; and
displaying an indication of the acknowledgement on the operating unit.

9. The method according to claim 8, wherein receiving the instruction at the operating unit occurs in response to touch by the user.

10. The method according to claim 8, wherein displaying the indication of the acknowledgement comprises graphically displaying a status message, an error message, or an operating instruction.

11. The method according to claim 8, wherein receiving the instruction at the operating unit occurs in response to spoken words from the user.

12. The method according to claim 8, wherein receiving the instruction at the operating unit occurs in response to movement of the operating unit.

13. The method according to claim 8, wherein receiving the instruction is initiated time-controlled by the operating unit.
